(19) United States
(12) Patent Application Publication
(10) Pub. No.: US 2023/0392619 A1
(43) Pub. Date: Dec. 7, 2023

(54) DEVICE FOR DETECTING ELONGATION OF HYDRAULIC CYLINDER

(71) Applicant: JiangSu XCMG Construction Machinery Research Institute LTD., Jiangsu (CN)

(72) Inventors: Xinchun CHEN, Jiangsu (CN); Xuemei ZONG, Jiangsu (CN); Can WANG, Jiangsu (CN)

(73) Assignee: JiangSu XCMG Construction Machinery Research Institute LTD., Jiangsu (CN)

(21) Appl. No.: 18/033,073

(22) PCT Filed: Apr. 15, 2021
(86) PCT No.: PCT/CN2021/087348

§ 371 Date: Apr. 21, 2023

(30) Foreign Application Priority Data
Oct. 22, 2020 (CN) 202011136688.8

(51) Int. Cl. F15B 15/28

(52) U.S. Cl. CPC F15B 15/2861

(57) ABSTRACT

A device for detecting the elongation of a hydraulic cylinder includes an electric signal conversion device, a ruler and a positional magnetic ring. The electric signal conversion device is disposed at the bottom of a cylinder barrel. The ruler has an end fixedly connected to the electric signal conversion device, as well as the other end movably extending into a piston rod. The positional magnetic ring is fixedly connected to a piston and the positional magnetic is movably disposed around the periphery of the ruler. When the positional magnetic ring is located at different positions of the ruler, different circuits are turned on to transmit a voltage or current signal corresponding to the positions of the ruler to the electric signal conversion device, so as to obtain a position of the positional magnetic ring on the ruler, such that the elongation of the piston rod is obtained.

### BACKGROUND

### Technical Field

The invention relates to the technical field of elongation detection, in particular to a device for detecting the elongation of a hydraulic cylinder.

### Description of Related Art

Hydraulic cylinders, as a hydraulic actuating element for converting hydraulic energy into mechanical energy for linear motions, are widely used in industrial fields such as engineering machines, machine tools, and ocean engineering machines. Detection of the elongation of hydraulic cylinders is a key technical base of intelligent control of industrial equipment. In recent years, the detection of the elongation of hydraulic cylinders has garnered wide attention. Traditional devices for detecting the elongation of hydraulic cylinders have the following problems: first, the devices are disposed outside the hydraulic cylinders, thus being prone to damage and poor in environmental adaptability; second, the devices are complex in structure, high in manufacturing cost, and inconvenient to install; and third, the devices are high in material cost, consume much time and labor when assembled, and poor in vibration resistance.

### SUMMARY

The objective of the invention is to provide a device for detecting the elongation of a hydraulic cylinder. The device is disposed in the hydraulic cylinder, good in environmental adaptability, simple in structure, easy to implement, low in manufacturing cost, and high in vibration resistance.

The technical objective of the invention is fulfilled through the following technical solution:

A device for detecting the elongation of a hydraulic cylinder comprises:

An electric signal conversion device disposed at a bottom of a cylinder barrel;

A ruler having an end fixedly connected to the electric signal conversion device, as well as an end movably extending into a piston rod; and

A positional magnetic ring fixedly connected to a piston and movably disposed around a periphery of the ruler;

Wherein, when the positional magnetic ring is located at different positions of the ruler, different circuits are turned on to transmit a voltage or current signal corresponding to the positions of the ruler to the electric signal conversion device, so as to obtain a position of the positional magnetic ring on the ruler, such that the elongation of the piston rod is obtained.

Further, the ruler is composed of an electrically conductive tube and an electromagnetic induction device disposed in the electrically conductive tube, and the electrically conductive tube has an end fixed to the bottom of a cylinder barrel and fixedly connected to the electric signal conversion device, as well as an end disposed in an axial hole of the piston rod.

Further, the end, disposed in the axial hole of the piston rod, of the electrically conductive tube is closed.

Further, the electromagnetic induction device is composed of a printed circuit board and tunnel magnetoresistive sensor chips disposed on the printed circuit board, and the printed circuit board is disposed in an inner hole of the electrically conductive tube and is parallel with an axis of the electrically conductive tube.

Further, the printed circuit is connected with a support member for preventing the printed circuit from bending in the electrically conductive tube.

Further, the support member is an elastic support ring.

Further, the tunnel magnetoresistive sensor chips are distributed on the printed circuit in one row at equal intervals, or distributed in multiple rows at equal intervals, or distributed at equal intervals merely within an operating range of the piston rod.

Further, each tunnel magnetoresistive sensor chip is composed of a first ferromagnetic layer, a non-magnetic insulating layer and a second ferromagnetic layer which are stacked together; and under the action of the positional magnetic ring, if magnetization directions of the first ferromagnetic layer and the second ferromagnetic layer are parallel, the tunnel magnetoresistive sensor chip is in a low impedance mode, a circuit is in an on state, and the circuit corresponding to the position, where the positional magnetic ring is located, of the ruler is turned on to transmit the voltage or current signal corresponding to the position of the ruler to the electric signal conversion device.

Further, the positional magnetic ring is composed of a magnet fixing structure and magnets disposed on the ring-shaped magnet fixing structure, and the magnet fixing structure is fixedly connected and coaxial with the piston, is coaxial with the ruler, and is driven by the piston to slide in an axial direction of the ruler.

Further, the magnet fixing structure is ring-shaped, the magnets are uniformly distributed on the magnet fixing structure in a circumferential direction, and the magnet fixing structure is fixed in the piston and is movably disposed around the periphery of the ruler.

The invention has the following beneficial effects:

The device for detecting the elongation of a hydraulic cylinder is simple in structure, easy to implement, wide in application range, easy to adjust, and capable of moving adaptively and flexibly.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is an assembled view of a device for detecting the elongation of a hydraulic cylinder and the hydraulic cylinder according to one embodiment of the invention;

FIG. 2 is a structural view of a ruler according to one embodiment of the invention;

FIG. 3 is a first structural view of a strip-shaped electromagnetic induction device according to one embodiment of the invention;

FIG. 4 is a second structural view of the strip-shaped electromagnetic induction device according to one embodiment of the invention;

FIG. 5 is a third structural view of the strip-shaped electromagnetic induction device according to one embodiment of the invention;

FIG. 6 is a structural view of a positional magnetic ring according to one embodiment of the invention;

FIG. 7 is a magnetoelectric principle diagram of elongation detection according to one embodiment of the invention.

### DESCRIPTION OF THE EMBODIMENTS

The invention will be described in further detail below in conjunction with the accompanying drawings.

It should be noted that all directional indications (such as “upper”, “lower”, “left”, “right”, “front” and “back”) in the embodiments of the invention are merely used to explain the relative positional relations and motions of components under a specific attitude; when the specific attitude changes, the directional indications will change accordingly. In addition, terms such as “install”, “dispose”, “provided with”, “link”, “connect” and “sleeve” should be broadly understood. For example, “connect” may refer to fixed connection, detachable connection or integral connection; or, mechanical connection or electrical connection; or, direct connection, indirect connection through an intermediate medium, or internal connection of two devices, elements, or parts. Those ordinarily skilled in the art can appreciate the specific meaning of these terms in the application as the case may be.

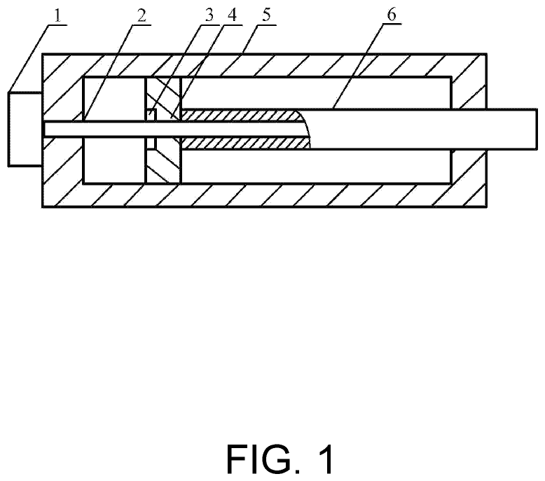

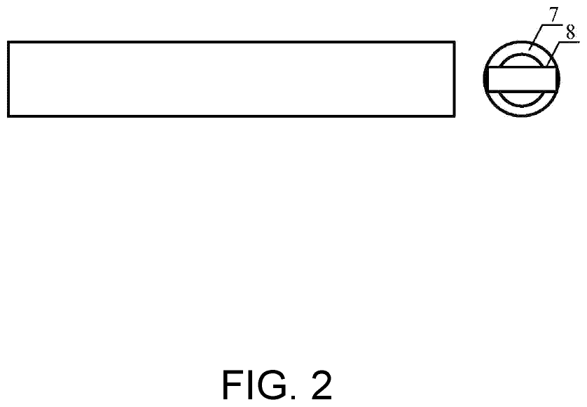

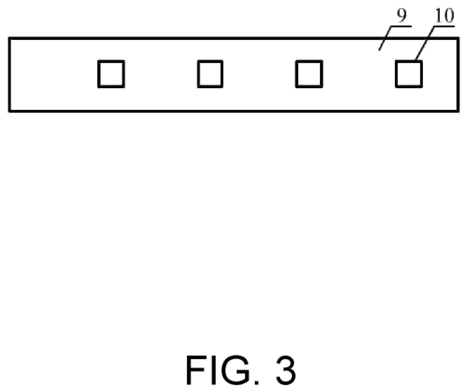

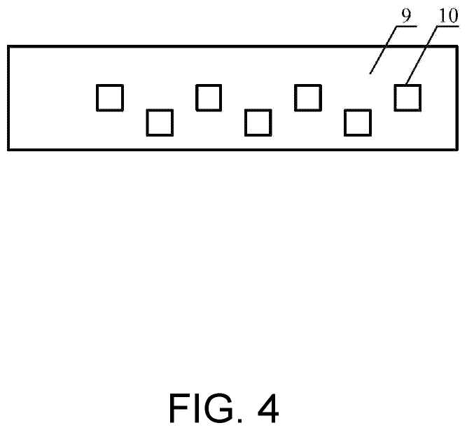

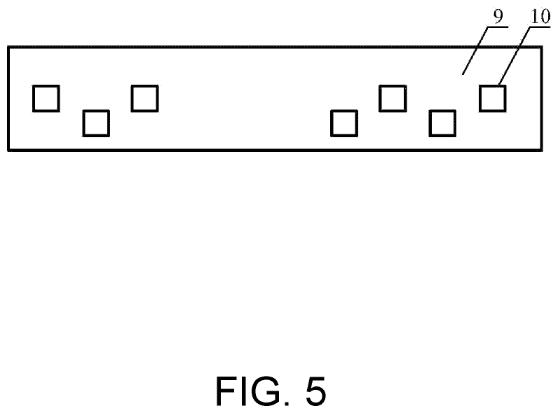

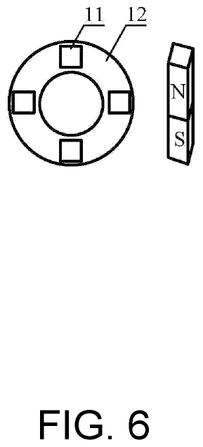

Referring to FIG. 1-FIG. 7, the invention provides a device for detecting the elongation of a hydraulic cylinder, which comprises an electric signal conversion device 1, a ruler 2, a positional magnetic ring 3, a piston 4, a cylinder barrel 5, a piston rod 6, a stainless steel tube 7, a strip-shaped electromagnetic induction device 8, a strip-shaped printed circuit board 9, tunnel magnetoresistive sensor chips 10, magnets 11, and a ring-shaped magnet fixing structure 12.

The electric signal conversion device 1 is used for transmitting a voltage or current signal in the strip-shaped electromagnetic induction device 8 to a controller to calculate and display the elongation of the piston rod 6. The ruler 2 is composed of the stainless steel tube 7 and the strip-shaped electromagnetic induction device 8, one end of the ruler 2 is fixed to the bottom of the cylinder barrel 5 and is fixedly connected to the electric signal conversion device 1, the other end of the ruler 2 is disposed in an axial hole of the piston rod 6, and an outer circle of the ruler 2 is sleeved and coaxial with an inner cylindrical surface of the positional magnetic ring 3. The positional magnetic ring 3 comprises the magnets 11 and the ring-shaped magnet fixing structure 12, is fixedly connected and coaxial with the piston 4, is coaxial with the ruler 2, and is driven by the piston 4 to slide in an axial direction of the ruler 2.

The piston 4, the cylinder barrel 5, and the piston rod 6 are basic components of a hydraulic cylinder. One end of the stainless steel tube 7 is fixed to the bottom of the cylinder barrel the other end of the stainless steel tube 7 is disposed in the axial hole of the piston rod 6, and an outer circle of the stainless steel tube 7 is sleeved and coaxial with the inner cylindrical surface of the positional magnetic ring 3; the stainless steel tube 7 is coaxial with the piston rod 6; and the other end of the stainless steel tube 7 is closed to prevent hydraulic oil from entering an inner hole of the stainless steel tube 7. The strip-shaped magnetic induction device 8 is composed of the strip-shaped printed circuit board 9 and the tunnel magnetoresistive sensor chips 10, is disposed in the inner hole of the stainless steel tube 7, and is parallel with the axis of the stainless steel tube 7; and elastic support rings are disposed on the strip-shaped magnetic induction device 8 at equal intervals (<200 mm) to prevent the strip-shaped magnetic induction device 8 from bending in the stainless steel tube 7. The strip-shaped printed circuit board 9 is disposed in the stainless steel tube 7, and the tunnel magnetoresistive sensor chips 10 are disposed on the strip-shaped printed circuit board 9; the tunnel magnetoresistive sensor chips 10 may be distributed in one row at equal intervals; or, in order to improve the detection precision, the tunnel magnetoresistive sensor chips 10 may be distributed in multiple rows at equal intervals in a crossed manner; or, in order to reduce the cost, the tunnel magnetoresistive sensor chips 10 may be distributed at unequal intervals, that is, the tunnel magnetoresistive sensor chips 10 are distributed at equal intervals only within the operating range of the piston rod 6. Each tunnel magnetoresistive sensor chip 10 is a sandwich structure formed by a first ferromagnetic layer, a non-magnetic insulating layer and a second ferromagnetic layer; under the action of an external magnetic field, if the magnetization directions of the ferromagnetic layers of the tunnel magnetoresistive sensor chip 10 are parallel, the tunnel magnetoresistive sensor chip 10 is in a low impedance mode, and a circuit is in an on state; otherwise, the circuit is in an off state; and under the action of the positional magnetic ring 3, the tunnel magnetoresistive sensor chip 10 makes the circuit in an on state, such that the circuit corresponding to the position, where the positional magnetic ring 3 is located, of the ruler 2 is turned on to transmit a voltage or current signal corresponding to the position of the ruler to the electric signal conversion device 1. The magnets 11 are uniformly disposed on the ring-shaped magnet fixing structure 12 in a circumferential direction, and the inner cylindrical surface of the positional magnetic ring 3 forms a magnetic induction line in the axial direction. The magnet fixing structure 12 is ring-shaped, and the magnets 11 are uniformly distributed on the ring-shaped magnet fixing structure 12 in the circumferential direction; and the ring-shaped magnet fixing structure 12 is fixed in the piston 4 and is disposed around the ruler 2.

In actual use, the positional magnetic ring 3 may be located on the tunnel magnetoresistive sensor chips 10 at different positions of the ruler 2 to turn on different circuits to transmit voltage or current signals corresponding these positions of the ruler 2 to the electric signal conversion device 1, so as to obtain the position of the positional magnet ring 3 on the ruler 2, such that the elongation of the piston rod 6 is obtained.

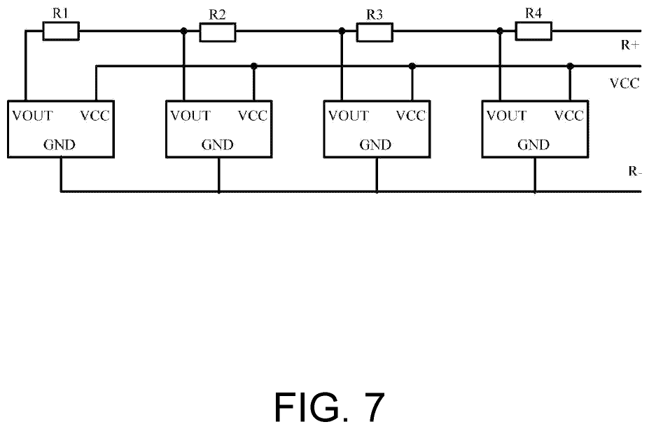

When the voltage or current in the circuit is calculated, as shown in FIG. 7, an external voltage VCC is accessed, and resistors in the circuit are R1, R2, R3 and R4 respectively. When the tunnel magnetoresistive sensor chip 10 corresponding to R1 is turned on under the action of the positional magnetic ring 3, the resistance in the circuit is R=R1+R2+R3+R4; when the tunnel magnetoresistive sensor chip 10 corresponding to R2 is turned on under the action of the positional magnetic ring 3, the resistance in the circuit is R=R2+R3+R4; when the tunnel magnetoresistive sensor chip 10 corresponding to R3 is turned on under the action of the positional magnetic ring 3, the resistance in the circuit is R=R3+R4; and when the tunnel magnetoresistive sensor chip 10 corresponding to R4 is turned on under the action of the positional magnetic ring 3, the resistance in the circuit is R=R4. In this way, corresponding voltage or current signals are obtained when the positional magnetic ring 3 is located on different tunnel magnetoresistive sensor chips 10, and thus, the elongation of the piston rod 6 is detected.

Although preferred embodiments of the invention are specifically described above, the invention can also be implemented in other forms different from those described above. All equivalent transformations or corresponding modifications made by any skilled in the art without departing from the spirit of the invention should fall within the protection scope of the invention.

1. A device for detecting the elongation of a hydraulic cylinder, comprising:
an electric signal conversion device disposed at a bottom of a cylinder barrel;
a ruler having an end fixedly connected to the electric signal conversion device, as well as an end movably extending into a piston rod; and
a positional magnetic ring fixedly connected to a piston and movably disposed around a periphery of the ruler;
wherein, when the positional magnetic ring is located at different positions of the ruler, different circuits are turned on to transmit a voltage or current signal corresponding to the positions of the ruler to the electric signal conversion device, so as to obtain a position of the positional magnetic ring on the ruler, such that the elongation of the piston rod is obtained.

2. The device for detecting the elongation of a hydraulic cylinder according to claim 1, wherein the ruler is composed of an electrically conductive tube and an electromagnetic induction device disposed in the electrically conductive tube, and the electrically conductive tube has an end fixed to the bottom of a cylinder barrel and fixedly connected to the electric signal conversion device, as well as an end disposed in an axial hole of the piston rod.

3. The device for detecting the elongation of a hydraulic cylinder according to claim 2, wherein the end, disposed in the axial hole of the piston rod, of the electrically conductive tube is closed.

4. The device for detecting the elongation of a hydraulic cylinder according to claim 1, wherein the electromagnetic induction device is composed of a printed circuit board and tunnel magnetoresistive sensor chips disposed on the printed circuit board, and the printed circuit board is disposed in an inner hole of an electrically conductive tube and is parallel with an axis of the electrically conductive tube.

5. The device for detecting the elongation of a hydraulic cylinder according to claim 4, wherein the printed circuit is connected with a support member for preventing the printed circuit from bending in the electrically conductive tube.

6. The device for detecting the elongation of a hydraulic cylinder according to claim 5, wherein the support member is an elastic support ring.

7. The device for detecting the elongation of a hydraulic cylinder according to claim 6, wherein the tunnel magnetoresistive sensor chips are distributed on the printed circuit in one row at equal intervals, or distributed in multiple rows at equal intervals, or distributed at equal intervals merely within an operating range of the piston rod.

8. The device for detecting the elongation of a hydraulic cylinder according to claim 6, wherein each said tunnel magnetoresistive sensor chip is composed of a first ferromagnetic layer, a non-magnetic insulating layer and a second ferromagnetic layer which are stacked together; and under the action of the positional magnetic ring, if magnetization directions of the first ferromagnetic layer and the second ferromagnetic layer are parallel, the tunnel magnetoresistive sensor chip is in a low impedance mode, a circuit is in an on state, and the circuit corresponding to the position, where the positional magnetic ring is located, of the ruler is turned on to transmit the voltage or current signal corresponding to the position of the ruler to the electric signal conversion device.

9. The device for detecting the elongation of a hydraulic cylinder according to claim 1, wherein the positional magnetic ring is composed of a magnet fixing structure and magnets disposed on the ring-shaped magnet fixing structure, and the magnet fixing structure is fixedly connected and coaxial with the piston, is coaxial with the ruler, and is driven by the piston to slide in an axial direction of the ruler.

10. The device for detecting the elongation of a hydraulic cylinder according to claim 9, wherein the magnet fixing structure is ring-shaped, the magnets are uniformly distributed on the magnet fixing structure in a circumferential direction, and the magnet fixing structure is fixed in the piston and is movably disposed around the periphery of the ruler.
